(19) United States
(12) Patent Application Publication
(10) Pub. No.: US 2019/0384544 A1
(43) Pub. Date: Dec. 19, 2019

(54) IMAGE FORMING APPARATUS

(71) Applicant: SHARP KABUSHIKI KAISHA, Osaka (JP)

(72) Inventors: YASUTOMO HAYANO, Osaka (JP); YASUHIRO NAKAI, Osaka (JP); KOHJI KATAMOTO, Osaka (JP); KOHICHI MURAKAMI, Osaka (JP); MASAO SAEDA, Osaka (JP)

(21) Appl. No.: 16/439,102

(22) Filed: Jun. 12, 2019

(30) Foreign Application Priority Data
Jun. 15, 2018 (JP) 2018-114714

(51) Int. Cl. G06F 3/12; G01S 15/04

(52) U.S. Cl. CPC G06F 3/1221; G03G 15/5016; G01S 15/04

(57) ABSTRACT

An image forming apparatus includes: a human detecting sensor that detects a person; and an operation unit that receives an operation, in which the operation unit receives a series of operations having a plurality of stages, and in a middle stage of the series of operations, in a case where a detection operation of a person by the human detecting sensor is not performed and a predetermined time lapses after the operation is received, the operation that is received is disabled.

### BACKGROUND

### 1. Field

The present disclosure relates to an image forming apparatus including a human detecting sensor that detects a person.

### 2. Description of the Related Art

An image forming apparatus, such as a copying machine, a facsimile machine, a printer, or a multifunction peripheral, which includes a human detecting sensor that detects a person and which operates in accordance with a detection result of the human detecting sensor has been conventionally known.

For energy-saving, the image forming apparatus including the human detecting sensor, for example, has a normal operation mode to operate upon supply of power and a power-saving mode which is a low power consumption state where less power is supplied than in the normal power state. The image forming apparatus may be configured to shift from the normal operation mode to the power-saving mode when a predetermined condition that is defined in advance is met (for example, when the image forming apparatus remains in a standby state for a predetermined time and/or when absence of a person near the apparatus is detected in accordance with the detection result of the human detecting sensor) or configured to return to the normal operation mode when presence of a person near the apparatus is detected in accordance with the detection result of the human detecting sensor in the power-saving mode.

For example, in a case where the image forming apparatus is configured to shift to the power-saving mode immediately when the human detecting sensor does not detect a person, however, an operation of shifting from the power-saving mode to the normal operation mode is necessarily performed when the image forming apparatus is to be used, thus posing a problem that it is difficult to use the image forming apparatus immediately. Further, in a case where the image forming apparatus is configured to shift to the power-saving mode when a fixed time has lapsed since the human detecting sensor did not detect a person, there is a problem that unnecessary power may be consumed. Thus, an image forming apparatus that achieves both convenience of a user and reduction of power consumption is proposed.

For example, Japanese Unexamined Patent Application Publication No. 2015-5905 discloses an image forming apparatus that includes a detection unit that detects a person, an operation unit that receives an operation of a user, and a processing unit that executes a job set by using the operation unit, in which timing for shift to a power-saving state is controlled on the basis of an execution state of the job while no person is detected. According to such an image forming apparatus, by switching power control to adapt to movement of an operator moving away from the operation unit, unnecessary power consumption is able to be suppressed while ensuring convenience of the operator.

Further, there is an image forming apparatus including a human detecting sensor that is configured to have a so-called auto-clear function of not only saving power of the entire image forming apparatus but also, when the human detecting sensor detects that there is no person near the apparatus, stopping display for performing an operation after lapse of a predetermined time and disabling a content of a previous operation.

Meanwhile, an image forming apparatus may be installed in an environment, such as a convenience store, in which unspecific numerous users use the image forming apparatus. In such a case, only a person who is familiar with an operation of the image forming apparatus does not necessarily use the image forming apparatus. For example, a person who does not know an operation method of the image forming apparatus uses the image forming apparatus while asking a staff of the convenience store or the like about the operation method. In addition, there is also a case where a user starts to operate the image forming apparatus without asking the staff or the like about the operation method and does not know the operation method in the middle, and goes to the staff or the like to ask the operation method. In such a case, since the user is apart from the image forming apparatus, the user is not detected by the human detecting sensor, and when a predetermined time lapses before the user comes back, auto-clear is performed and the user is requested to perform the operation, which has advanced halfway, again from the beginning, thus posing a problem of low convenience.

In order to avoid such problems, for example, a time up to when the auto-clear is performed after the user is not detected by the human detecting sensor may be lengthened. In such a case, however, when the user stops using the image forming apparatus after performing the operation in the middle and neglects the operation performed so far without cancel, a next user uses the image forming apparatus after performing a work to cancel the operation of the previous user, thus posing a problem of low convenience.

The disclosure is made in view of the aforementioned circumstances and provides an image forming apparatus capable of suppressing lowering of convenience of a user.

### SUMMARY

An image forming apparatus according to an aspect of the disclosure includes: a human detecting sensor that detects a person; and an operation unit that receives an operation, in which the operation unit receives a series of operations having a plurality of stages, and in a middle stage of the series of operations, in a case where a detection operation of a person by the human detecting sensor is not performed and a predetermined time lapses after the operation is received, the operation that is received is disabled.

Thereby, even when a user is apart from the image forming apparatus in the middle of the series of operations, an operation performed so far is not disabled until the predetermined time has lapsed. Thus, for example, even when the user does, for example, an action to ask an operation method of the image forming apparatus, the user is not requested to perform the operation again from the beginning, so that high convenience is achieved. When the predetermined time has lapsed, the operation performed so far is disabled, so that even when the user suspends and neglects the operation in the middle of the series of operations, the operation is disabled after the predetermined time has lapsed. Thereby, a next user is able to use the image forming apparatus immediately, so that high convenience is achieved.

### BRIEF DESCRIPTION OF THE DRAWINGS

FIG. 1 is a perspective view illustrating a schematic configuration of an image forming apparatus according to an embodiment of the disclosure;

FIG. 2 is a perspective view illustrating a detection range of a human detecting sensor in the image forming apparatus illustrated in FIG. 1;

FIG. 3 is a block diagram schematically illustrating a control configuration of a control unit in the image forming apparatus illustrated in FIG. 1;

FIG. 4 illustrates a table related to a time until auto-clear of the image forming apparatus according to the embodiment of the disclosure;

FIG. 5 is a flowchart illustrating an example of an operation related to auto-clear by the control unit in the image forming apparatus according to the embodiment of the disclosure;

FIG. 6 illustrates a portal screen of a display device in the image forming apparatus according to the embodiment of the disclosure;

FIGS. 7A to 7F each illustrate a display screen in each setting in the display device in the image forming apparatus according to a first embodiment;

FIGS. 8A to 8H each illustrate a display screen in each setting in a display device in an image forming apparatus according to a second embodiment; and

FIGS. 9A to 9G each illustrate a display screen in each setting in a display device in an image forming apparatus according to a third embodiment.

### DESCRIPTION OF THE EMBODIMENTS

Embodiments according to the disclosure will be described below with reference to drawings.

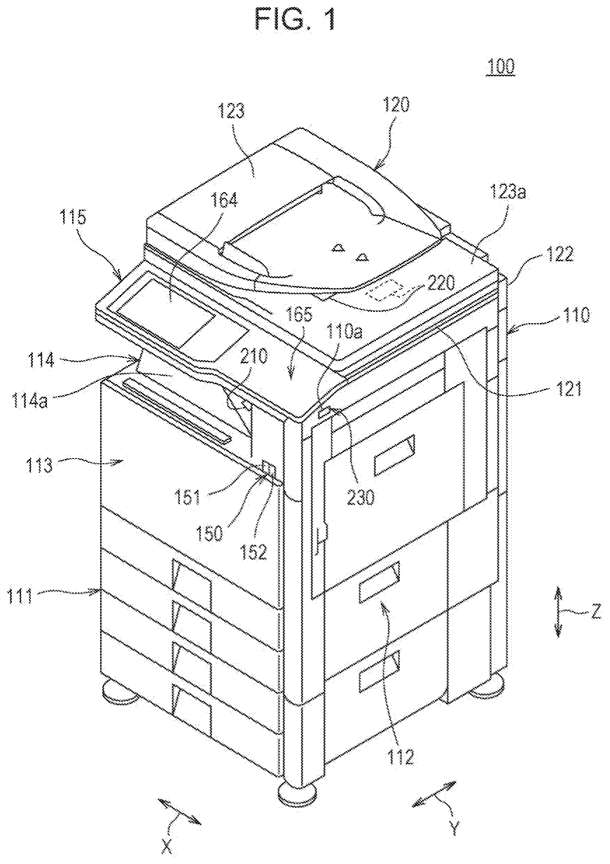

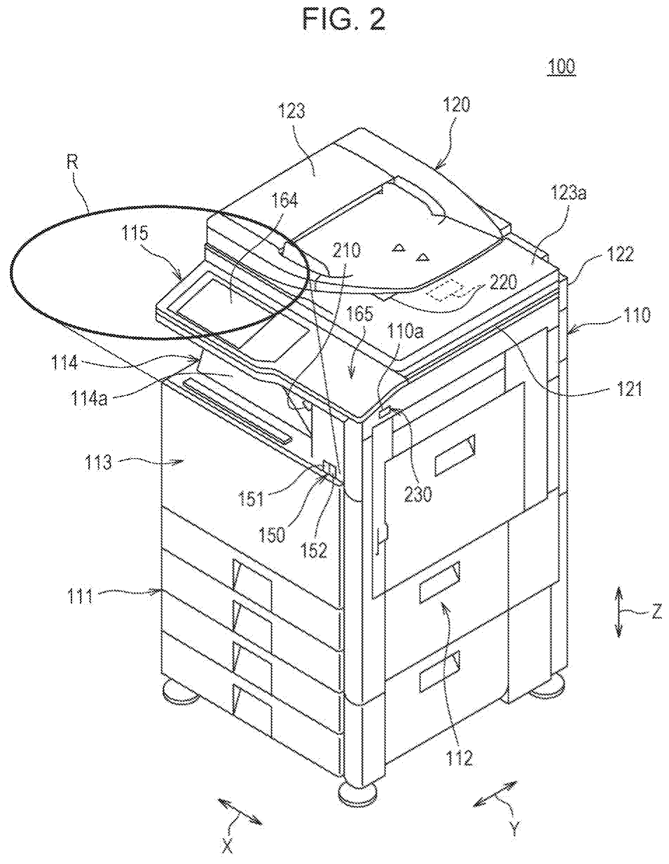

FIG. 1 is a perspective view illustrating a schematic configuration of an image forming apparatus 100 according to an embodiment of the disclosure. FIG. 2 is a perspective view illustrating a detection range R of a human detecting sensor 150 in the image forming apparatus 100 illustrated in FIG. 1. Note that, in FIGS. 1 and 2, a reference sign X indicates a horizontal direction, a reference sign Y indicates a depth direction, and a reference sign Z indicates a vertical direction.

As illustrated in FIGS. 1 and 2, the image forming apparatus 100 includes an image forming apparatus main body 110 and a document reading device 120.

The document reading device 120 is provided on a top of the image forming apparatus main body 110 and includes a document platen 121, a document reading unit 122, and an automatic document feeding device 123. The document reading device 120 reads an image of a document placed on the document platen 121 or an image of a document automatically fed by the automatic document feeding device 123, each by the document reading unit 122, and transmits image data of the read document to the image forming apparatus main body 110. The document reading device 120 discharges, to a document discharge tray 123a, the document fed by the automatic document feeding device 123 and read by the document reading unit 122.

The image forming apparatus main body 110 has a sheet accommodation unit 111, a sheet conveyance unit 112, an image forming unit 113, a sheet discharge unit 114, and an operation unit 115. The image forming apparatus main body 110 is configured to accommodate a recording sheet, such as paper for recording, in the sheet accommodation unit 111, convey the recording sheet, which is accommodated in the sheet accommodation unit 111, by the sheet conveyance unit 112, form, on the recording sheet conveyed by the sheet conveyance unit 112, a color image or a monochrome image by the image forming unit 113 on the basis of image data transmitted from the document reading device 120 or outside, and discharge the recording sheet on which the image is formed by the image forming unit 113 to a sheet discharge tray 114a in the sheet discharge unit 114. The operation unit 115 is provided with an operation member 165 including a display device 164. Note that, the display device 164 is a touch panel display and allows not only a display of an image related to an operation but also an input by contacting a screen of the display device 164.

In the present embodiment, the image forming apparatus 100 further includes the human detecting sensor 150 that detects a person.

The human detecting sensor 150 is provided in one end (right end in the present example) which is in the horizontal direction X as viewed from a front side and which is below the operation unit 115 on a front surface (operation-side surface) of the image forming apparatus main body 110.

The human detecting sensor 150 is a sensor that detects presence or absence of a person in the predetermined limited detection range R (refer to FIG. 2) that is defined in advance. The human detecting sensor 150 has directionality of the predetermined detection range R. The detection range R is able to exemplify a predetermined limited detection range in the horizontal direction X, the depth direction Y, the vertical direction Z, and a direction combining at least two of them, and is defined as a range in a conical shape extending upward in the horizontal direction X and the vertical direction Z in the present example (refer to FIG. 2).

The human detecting sensor 150 is an ultrasonic human detecting sensor using an ultrasonic wave in the present example. The ultrasonic human detecting sensor 150 has an ultrasonic emitter 151 and an ultrasonic receiver 152, emits the ultrasonic wave to a detection target in the predetermined detection range R by the ultrasonic emitter 151, and detects presence or absence of a target on the basis of a detection result obtained by receiving a reflected wave from the detection target by the ultrasonic receiver 152. The human detecting sensor 150 is the ultrasonic human detecting sensor using the ultrasonic wave in the present example, but may be a sensor other than the ultrasonic human detecting sensor, such as an infrared human detecting sensor using an infrared ray, an optical human detecting sensor using visible light, a pyroelectric human detecting sensor, a sound-sensing human detecting sensor, or a pressing-type human detecting sensor, and further may be other human detecting sensors. Furthermore, the human detecting sensor 150 may be a human detecting sensor combining two or more kinds of the human detecting sensors.

Note that, a first detection unit 210, a second detection unit 220, and a third detection unit 230 that are not described in FIGS. 1 and 2 will be described below.

### [Control Unit]

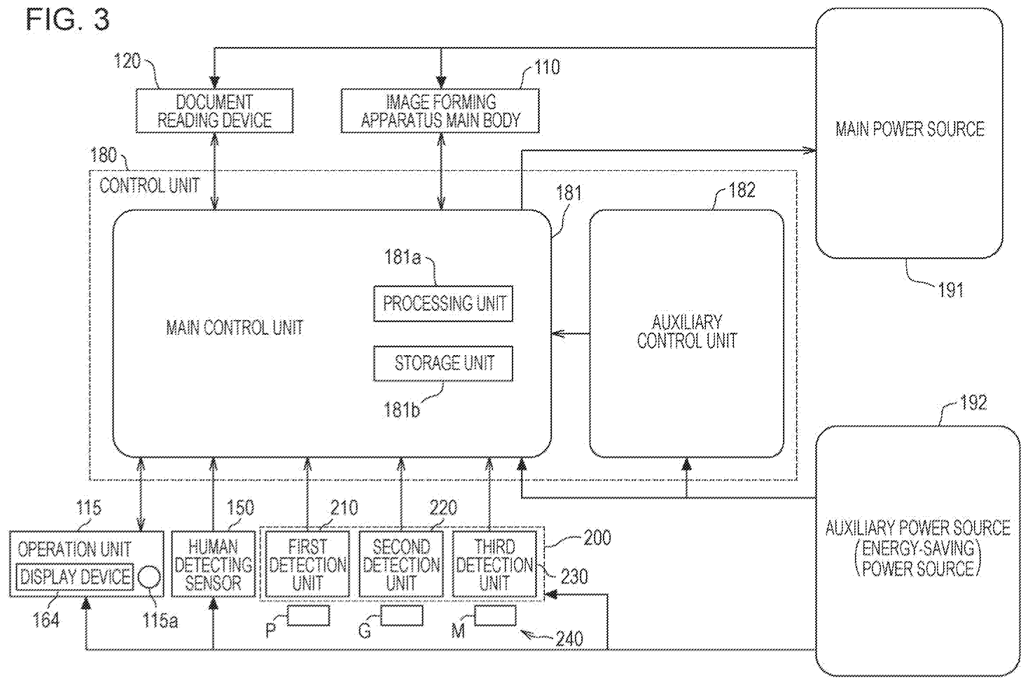

The image forming apparatus 100 further includes a control unit 180 (refer to FIG. 3) that controls the image forming apparatus 100 as a whole. Here, the image forming apparatus 100 has functions of copy, print, fax, scanner, and the like and the control unit 180 directs operations of the functions.

FIG. 3 is a block diagram schematically illustrating a control configuration of the control unit 180 in the image forming apparatus 100 illustrated in FIG. 1.

Here, the control unit 180 has a power-saving mode in which the image forming apparatus 100 is turned from a high power consumption state into a low power consumption state where less energy is supplied than in the high power consumption state. Here, the low power consumption state in the power-saving mode has a concept also including a state where no power is supplied from a power source (a main power source 191 in the present example).

In the present example, the control unit 180 is configured to bring the power-saving mode when a predetermined condition that is defined in advance is met (for example, when the image forming apparatus 100 remains in a standby state for a predetermined time and/or when absence of a person is detected in accordance with a detection result of the human detecting sensor 150). In the present example, the standby state is an image forming operation standby state. Here, the image forming operation standby state means a state where an image forming operation is able to start immediately, specifically, a state where prescribed power by which a fixing temperature reaches a prescribed temperature (for example, 170° C.) in the image forming operation is supplied to a fixing unit in the image forming apparatus main body 110 and the fixing temperature is kept at the prescribed temperature (for example, 170° C.) and also where the control unit 180 is started up. Further, the power-saving mode in the present example means a state where power-saving power by which the fixing temperature reaches a predetermined power-saving temperature (for example, 150° C.) that is lower than the prescribed temperature (for example, 170° C.) in the image forming operation is supplied to the fixing unit in the image forming apparatus main body 110, and also where the control unit 180 is started up. Accordingly, in the present example, the high power consumption state means the standby state and the low power consumption state means the state in the power-saving mode. That is, the image forming apparatus 100 has a normal operation mode (high power consumption state) to operate upon supply of power and the power-saving mode (low power consumption state) in which power supply is saved. Note that, the prescribed temperature and the power-saving temperature are respectively not limited to 170° C. and 150° C. and are merely examples. The power-saving temperature may be set to a temperature lower than the prescribed temperature.

In the power-saving mode, when presence of a person is detected in accordance with the detection result of the human detecting sensor 150, the control unit 180 is configured to return from the low power consumption state in the power-saving mode to the high power consumption state.

Specifically, the image forming apparatus 100 includes the main power source 191 and an auxiliary power source 192 (energy-saving power source) as illustrated in FIG. 3. Note that, such a configuration is an example of a specific implementation method.

The main power source 191 is electrically connected to the control unit 180 (a main control unit 181 in the present example) by a control system line indicated by a thin line, and electrically connected to the image forming apparatus main body 110 and the document reading device 120 by a power system line indicated by a thick line.

To bring the image forming apparatus 100 into the image forming operation standby state, the control unit 180 (the main control unit 181 in the present example) is configured to transmit, to the main power source 191, an instruction signal indicating that the image forming apparatus 100 is brought into the image forming operation standby state or an instruction signal indicating that the image forming apparatus 100 is brought into the power-saving mode.

The control unit 180 (the main control unit 181 in the present example) includes a processing unit 181a composed of a microcomputer such as a central processing unit (CPU), and a storage unit 181b including a storage device such as a read only memory (ROM), a random access memory (RAM), or a data rewritable non-volatile memory.

The control unit 180 (the main control unit 181 in the present example) is configured to control operations of various components by causing the processing unit 181a to load and run a control program, which is stored in advance in the ROM in the storage unit 181b, on the RAM in the storage unit 181b. The RAM in the storage unit 181b provides the processing unit 181a with an operational work area and an area as an image memory for storing image data.

The auxiliary power source 192 is electrically connected to the control unit 180 (the main control unit 181 and an auxiliary control unit 182 in the present example), the human detecting sensor 150, and the operation unit 115 by a power system line indicated by a thick line, and is configured to constantly supply power to the control unit 180 (the main control unit 181 and the auxiliary control unit 182 in the present example), the human detecting sensor 150, and the operation unit 115.

The human detecting sensor 150 is electrically connected to an input system of the control unit 180 (the main control unit 181 in the present example) by a control system line indicated by a thin line, and is configured to transmit a signal indicating presence of a person or a signal indicating absence of a person to the control unit 180. Thereby, the human detecting sensor 150 is able to cause the control unit 180 to recognize whether a person is present or absent.

The operation unit 115 is electrically connected to the control unit 180 (the main control unit 181 in the present example) by a control system line indicated by a thin line, and is configured to transmit operation information to the control unit 180 or display display information transmitted from the control unit 180. The operation unit 115 includes an alarm buzzer 115a and is configured to produce an alarm by the alarm buzzer 115a in response to an instruction signal transmitted from the control unit 180.

The control unit 180 (the main control unit 181 in the present example) also controls execution of so-called auto-clear in which, when a user is apart from the image forming apparatus 100 while inputting an operation of the image forming apparatus 100 by the operation unit 115, an operation content that is being input is disabled and display of the display device 164 is returned to a portal screen as initial display. According to the image forming apparatus 100, with such an auto-clear function, for example, even when the user suspends and neglects an operation in the middle of a series of operations, the operation content is disabled after a lapse of a predetermined time and a next user is able to immediately use the image forming apparatus 100.

When a signal indicating absence of a person is received from the human detecting sensor 150 in a middle stage of a series of operations having a plurality of stages, after a lapse of a predetermined time, the control unit 180 instructs the operation unit 115 to disable an operation that is input up to the middle stage. The control unit 180 also instructs the display device 164 to display the portal screen. Here, the series of operations is, for example, operations related to copy processing, fax processing, print processing, and the like and is processing that is completed by operations with a plurality of stages. Note that, corresponding setting is prescribed for each of the plurality of stages in the series of operations. The setting is also prescribed correspondingly to a display screen in the display device 164.

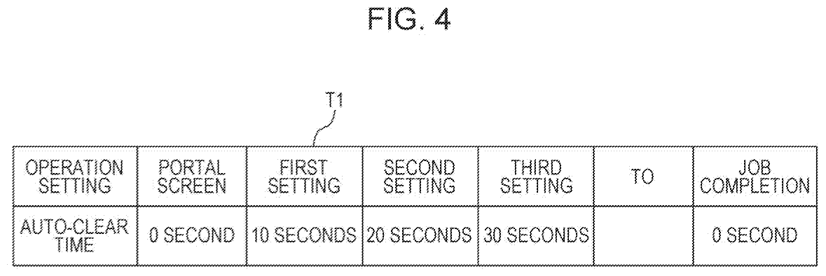

Further, a predetermined time until auto-clear is performed is decided in advance in accordance with the setting and data thereof (refer to FIG. 4) is stored in the ROM of the storage unit 181b in advance.

FIG. 4 illustrates a table T1 related to a time until auto-clear of the image forming apparatus 100 according to the embodiment of the disclosure.

As illustrated in FIG. 4, in the table T1, times (auto-clear times) until the auto-clear in the portal screen of the display device 164, first setting, second setting, third setting, and job completion (completion of a series of operations) are respectively prescribed as 0 second, 10 seconds, 20 seconds, 30 seconds, and 0 second. Note that, description for fourth and subsequent setting is omitted. Here, the first setting, the second setting, and the third setting indicate respective stages of the series of operations, and as a stage advances, the auto-clear time increases.

The control unit 180 receives, from the operation unit 115, a signal related to setting in an operation currently input by the user, and decides the time until the auto-clear by referring to the table T1 stored in the storage unit 181b.

As illustrated in FIG. 3, the image forming apparatus 100 includes an article detection unit 200 that detects a remaining article 240 (in the present example, at least one of a recording sheet P, a document G, and a storage medium M) that is to be removed by the user after image formation, and is configured to disable a detection result of the human detecting sensor 150 when it is detected that the remaining article 240 remains after image formation in accordance with a detection result of the article detection unit 200.

Specifically, the auxiliary power source 192 is electrically connected to the article detection unit 200 (210 to 230) by a power system line indicated by a thick line, and is configured to constantly supply power to the article detection unit 200 (210 to 230).

The article detection unit 200 includes at least one (in the present example, the first detection unit 210, the second detection unit 220, and the third detection unit 230) of the first detection unit 210 (refer to FIG. 1 and the like) that detects presence or absence of the recording sheet P after image formation, the second detection unit 220 (refer to FIG. 1 and the like) that detects presence or absence of the document G after image formation, and the third detection unit 230 (refer to FIG. 1 and the like) that detects presence or absence of the storage medium M, which is attachable to or detachable from the image forming apparatus main body 110 (specifically, a connection connector 110a (refer to FIG. 1 and the like) provided in the operation unit 115), after image formation.

An actuator switch or a reflective photosensor that is turned on or off in accordance with presence or absence of the recording sheet P is able to be exemplified as the first detection unit 210, and an actuator switch or a reflective photosensor that is turned on or off in accordance with presence or absence of the document G is able to be exemplified as the second detection unit 220. Further, a universal serial bus (USB) (registered trademark) memory or a secure digital (SD) memory card is able to be representatively exemplified as the storage medium M, and an interface (for example, a USB (registered trademark) memory interface or an SD memory card interface) that transmits a signal which brings a connection state or a non-connection state in accordance with presence or absence of the storage medium M is able to be exemplified as the third detection unit 230.

The first detection unit 210 is electrically connected to the input system of the control unit 180 (in the present example, the main control unit 181) by a control system line indicated by a thin line and is configured to transmit, to the control unit 180, a signal indicating that the recording sheet P after image formation is left in the sheet discharge tray 114a in the sheet discharge unit 114 or a signal indicating that the recording sheet P is not left. Thereby, the first detection unit 210 is able to cause the control unit 180 to recognize whether the recording sheet P is left in the sheet discharge tray 114a.

The second detection unit 220 is electrically connected to the input system of the control unit 180 (in the present example, the main control unit 181) by a control system line indicated by a thin line and is configured to transmit, to the control unit 180, a signal indicating that the document G after image formation is left in the document platen 121 or the document discharge tray 123a in the automatic document feeding device 123 or a signal indicating that the document G is not left. Thereby, the second detection unit 220 is able to cause the control unit 180 to recognize whether the document G is left in the document platen 121 or the document discharge tray 123a.

The third detection unit 230 is electrically connected to the input system of the control unit 180 (in the present example, the main control unit 181) by a control system line indicated by a thin line and is configured to transmit, to the control unit 180, a signal indicating that the storage medium M after image formation is left in the connection connector 110a in the operation unit 115 of the image forming apparatus main body 110 or a signal indicating that the storage medium M is not left. Thereby, the third detection unit 230 is able to cause the control unit 180 to recognize whether the storage medium M is left in the connection connector 110a.

Next, a control operation related to auto-clear by the control unit 180 in the image forming apparatus 100 will be described.

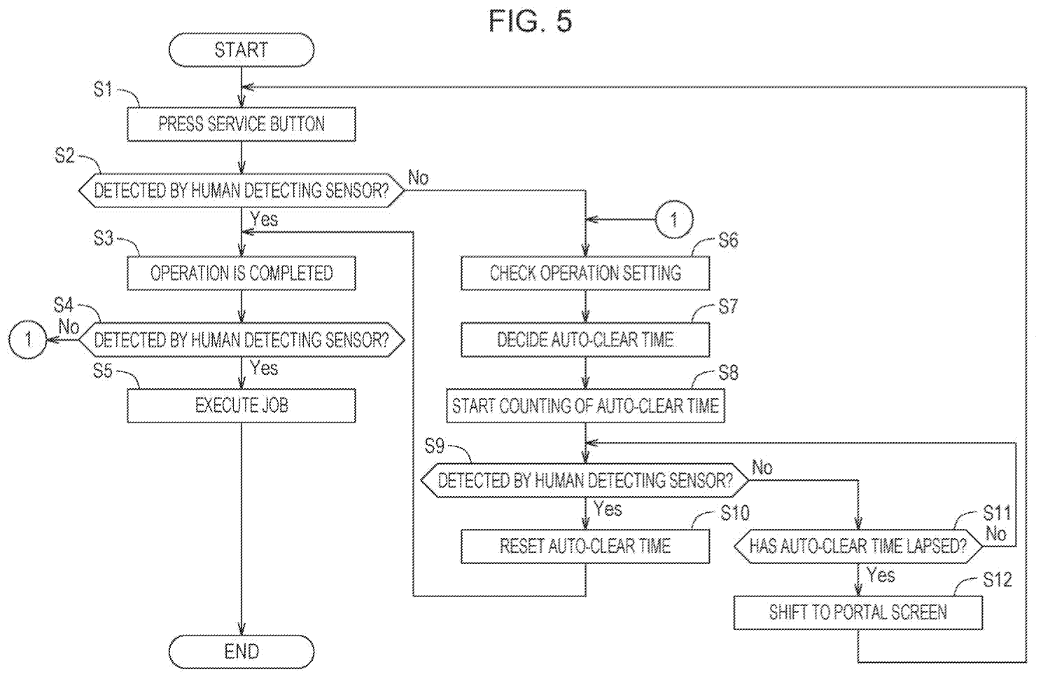

FIG. 5 is a flowchart illustrating an example of an operation related to auto-clear by the control unit in the image forming apparatus according to the embodiment of the disclosure.

In the flowchart illustrated in FIG. 5, first, when recognizing that the user presses a service button in a state where the portal screen is displayed in the display device 164 (step S1), the control unit 180 determines whether presence of a person is detected in accordance with the detection result of the human detecting sensor 150 (step S2). In a case where the control unit 180 detects presence of a person in accordance with the detection result of the human detecting sensor 150 (step S2: Yes), when recognizing that a series of operations by the user is completed (step S3), the control unit 180 determines whether presence of a person is detected in accordance with the detection result of the human detecting sensor 150 (step S4). In a case where the control unit 180 detects presence of a person in accordance with the detection result of the human detecting sensor 150 (step S4: Yes), the control unit 180 executes a job corresponding to the series of operations (step S5).

In a case where the control unit 180 detects absence of a person in accordance with the detection result of the human detecting sensor 150 at step S2 (step S2: No) and in a case where the control unit 180 detects absence of a person in accordance with the detection result of the human detecting sensor 150 at step S4 (step S4: No), the control unit 180 checks setting in a current operation (step S6).

The control unit 180 refers to the table T1 and decides an auto-clear time on the basis of the current setting that is checked (step S7) and starts counting of the auto-clear time (step S8). After starting counting of the auto-clear time, the control unit 180 determines whether presence of a person is detected in accordance with the detection result of the human detecting sensor 150 (step S9), and in a case where the control unit 180 detects presence of a person in accordance with the detection result of the human detecting sensor 150 (step S9: Yes), the control unit 180 stops counting of the auto-clear time and resets the auto-clear time (step S10), and the procedure proceeds to step S3.

In a case where the control unit 180 detects absence of a person in accordance with the detection result of the human detecting sensor 150 (step S9: No), the control unit 180 determines whether the auto-clear time has lapsed (step S11), and in a case where the auto-clear time has lapsed (step S11: Yes), the control unit 180 causes the display device 164 to display the portal screen (step S12), and the procedure proceeds to step S1. That is, the control unit 180 executes the auto-clear by disabling the series of operations.

In a case where the auto-clear time has not lapsed (step S11: No), the procedure proceeds to step S9.

### First Embodiment

In a first embodiment, a case where the user selects copy processing as a job will be described.

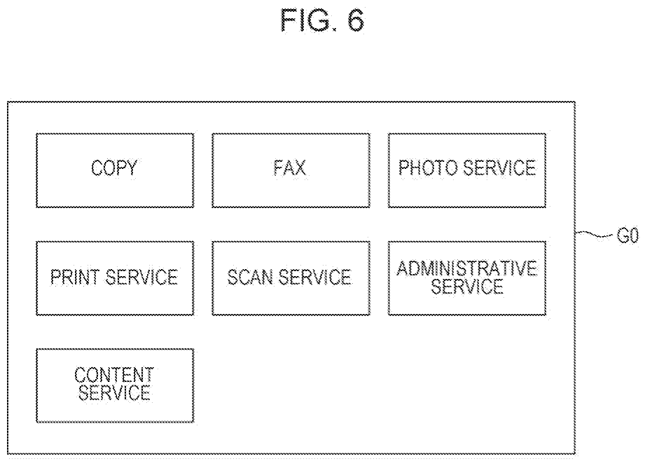

FIG. 6 illustrates a portal screen G0 of the display device 164 in the image forming apparatus 100 according to the embodiment of the disclosure.

As illustrated in FIG. 6, when the image forming apparatus 100 is in a usable state, the portal screen G0 is displayed in the display device 164. In the portal screen G0, “copy”, “fax”, “print service”, and the like are displayed and a job of any of them is able to be selected.

When the user selects “copy” in the display device 164, a signal indicating performing copy processing is transmitted to the control unit 180. Specifically, when the user touches a place where “copy” is displayed in the display device 164, a signal related to the place touched by the user is transmitted to the control unit 180 and the control unit 180 recognizes, from the signal, that the copy processing is to be performed.

When the user selects the copy processing, the display of the display device 164 shifts to a screen for performing the copy processing.

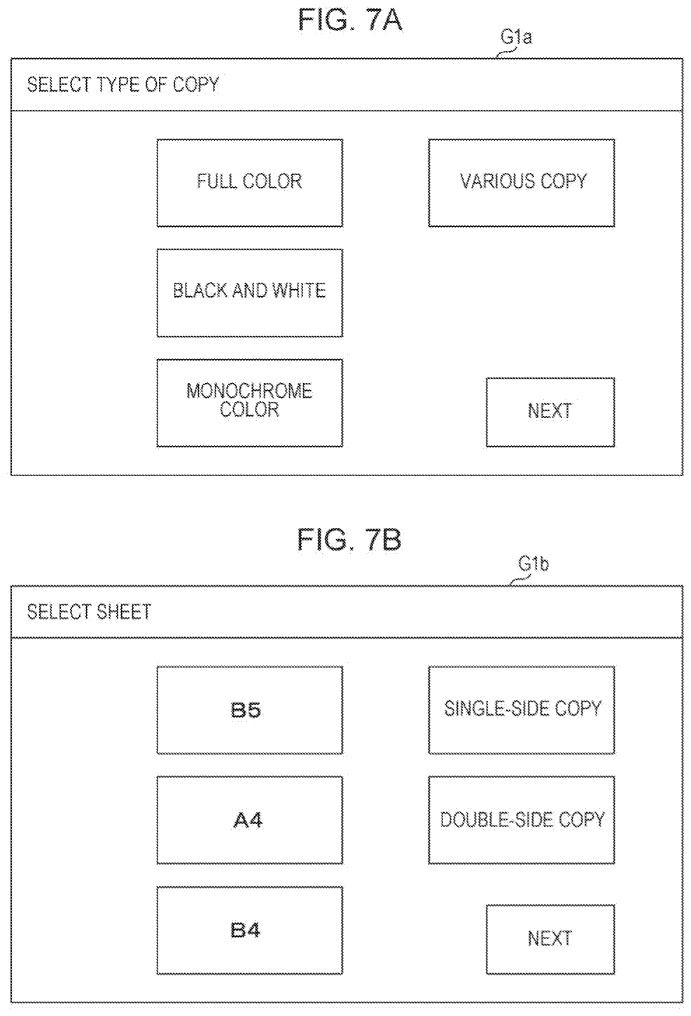

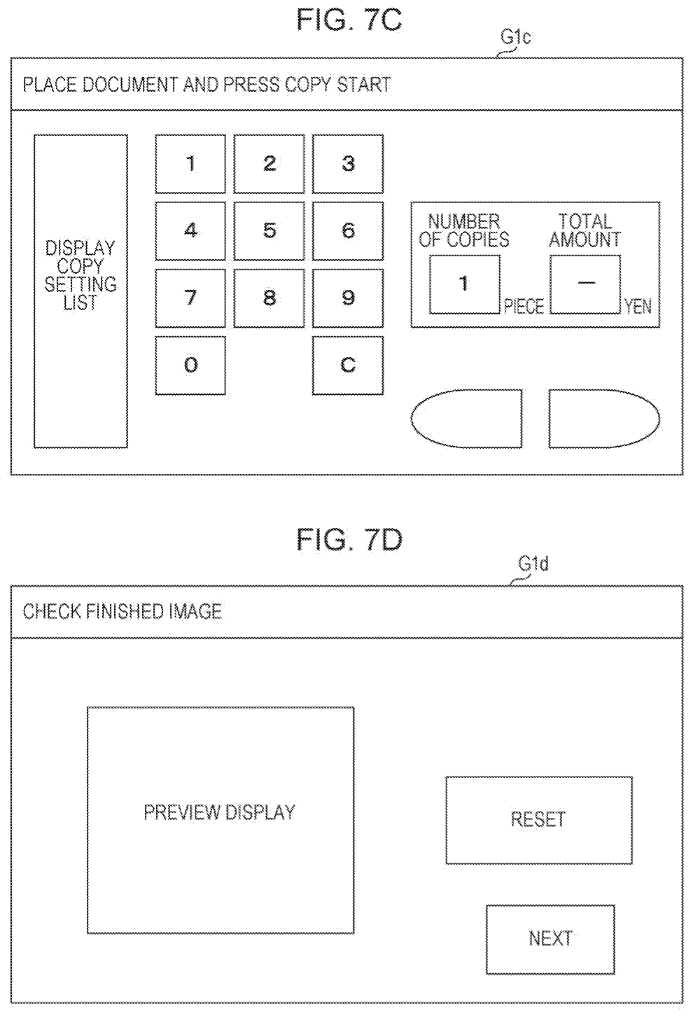

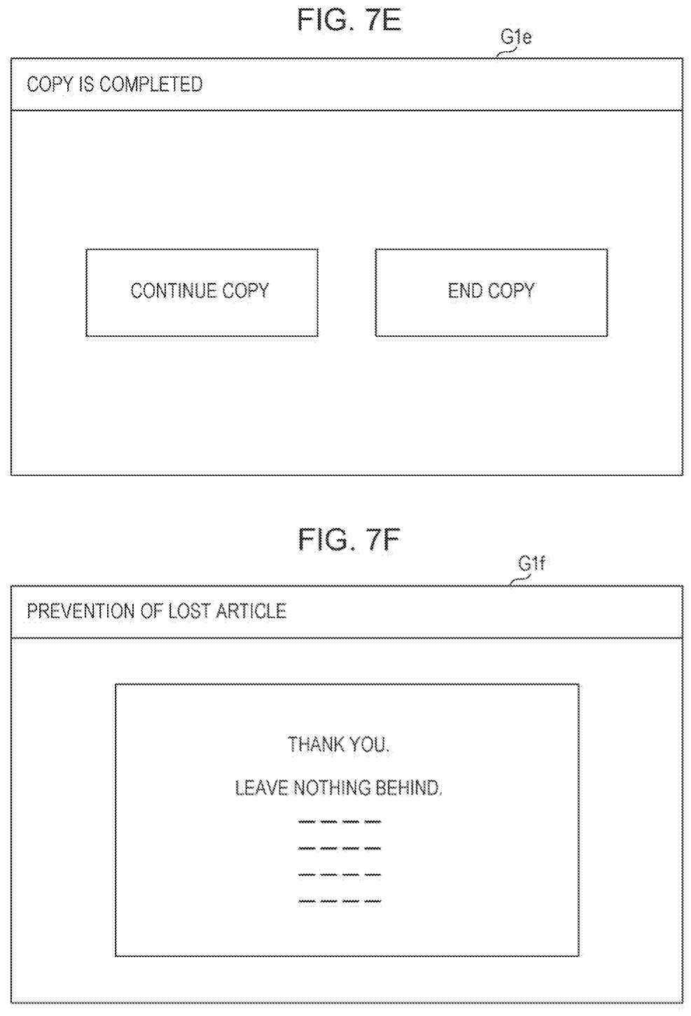

FIGS. 7A to 7F each illustrate a display screen in each setting in the display device in the image forming apparatus according to the first embodiment, and specifically each illustrate a screen for performing the copy processing.

When the user selects “copy” in the display device 164, the display device 164 changes the display from the portal screen G0 to a screen G1a illustrated in FIG. 7A.

The screen G1a is a screen in which a type of copy is selected. Here, a state where the screen G1a is displayed in the display device 164 corresponds to first setting in a series of operations. Thus, in a case where the user is apart from the image forming apparatus 100 when the screen G1a is displayed, after 10 seconds of detecting by the control unit 180 absence of a person in accordance with the detection result of the human detecting sensor 150 (refer to FIG. 4), the display of the display device 164 is changed to the portal screen G0 and the auto-clear is executed. Note that, the display is changed to the portal screen G0 when absence of a person is continuously detected for 10 seconds, and when the user comes back within 10 seconds and the control unit 180 detects presence of a person in accordance with the detection result of the human detecting sensor 150, the screen G1a remains displayed and the auto-clear is not executed.

When the user selects a type of copy in the screen G1a, the display device 164 changes the display from the screen G1a to a screen G1b illustrated in FIG. 7B.

The screen G1b is a screen in which a sheet is selected. Here, a state where the screen G1b is displayed in the display device 164 corresponds to second setting in the series of operations. Thus, in a case where the user is apart from the image forming apparatus 100 when the screen G1b is displayed, after 20 seconds of detecting by the control unit 180 absence of a person in accordance with the detection result of the human detecting sensor 150 (refer to FIG. 4), the display of the display device 164 is changed to the portal screen G0 and the auto-clear is executed.

When the user selects a sheet in the screen G1b, the display device 164 changes the display from the screen G1b to a screen G1c illustrated in FIG. 7C.

The screen G1c is a screen in which the number of copies or the like is selected and start of copying is instructed. Here, a state where the screen G1c is displayed in the display device 164 corresponds to third setting in the series of operations. Thus, in a case where the user is apart from the image forming apparatus 100 when the screen G1c is displayed, after 30 seconds of detecting the control unit 180 absence of a person in accordance with the detection result of the human detecting sensor 150 (refer to FIG. 4), the display of the display device 164 is changed to the portal screen G0 and the auto-clear is executed.

When the user selects the number of copies and instructs start of copying in the screen G1c, the display device 164 changes the display from the screen G1c to a screen G1d illustrated in FIG. 7D.

The screen G1d is a screen in which whether to perform preview display of copy is selected. Here, a state where the screen G1d is displayed in the display device 164 corresponds to fourth setting in the series of operations. Thus, in a case where the user is apart from the image forming apparatus 100 when the screen G1d is displayed, similarly to the description with reference to FIGS. 7A to 7C, the auto-clear time is decided, and when the user does not come back within the decided auto-clear time, the display of the display device 164 is changed to the portal screen G0 and the auto-clear is executed.

When the user selects not to perform preview display in the screen G1d, the copy processing is executed and the display device 164 changes the display from the screen G1d to a screen G1e illustrated in FIG. 7E.

The screen G1e is a screen in which whether to continuously perform copying is selected. Here, a state where the screen G1e is displayed in the display device 164 corresponds to fifth setting in the series of operations. Thus, in a case where the user is apart from the image forming apparatus 100 when the screen G1e is displayed, similarly to the description with reference to FIGS. 7A to 7C, the auto-clear time is decided, and when the user does not come back within the decided auto-clear time, the display of the display device 164 is changed to the portal screen G0 and the auto-clear is executed.

When the user selects to end the copy without continuously performing copy in the screen G1e, a job related to the copy processing is completed and the display device 164 changes the display from the screen G1e to a screen G1f illustrated in FIG. 7F.

The screen G1f is an end screen. Note that, in a case where the user is apart from the image forming apparatus 100 when the screen G1f is displayed, the display of the display device 164 is immediately changed to the portal screen G0 (refer to FIG. 4).

Note that, the auto-clear time in the portal screen G0 is 0 second in the table T1, but in a case where the user is apart from the image forming apparatus 100 when the display device 164 displays the portal screen G0, the display of the display device 164 may be immediately turned out. Thereby, a power-saving effect is exerted.

### Second Embodiment

In a second embodiment, description for the same point as that of the first embodiment will be omitted and only a difference therefrom will be primarily described.

In the second embodiment, a case where the user selects fax processing as a job will be described. The user touches the display device 164 when the portal screen G0 is displayed in the display device 164 (refer to FIG. 6) and thereby selects “fax”.

When the user selects the fax processing, the display of the display device 164 shifts to a screen for performing the fax processing.

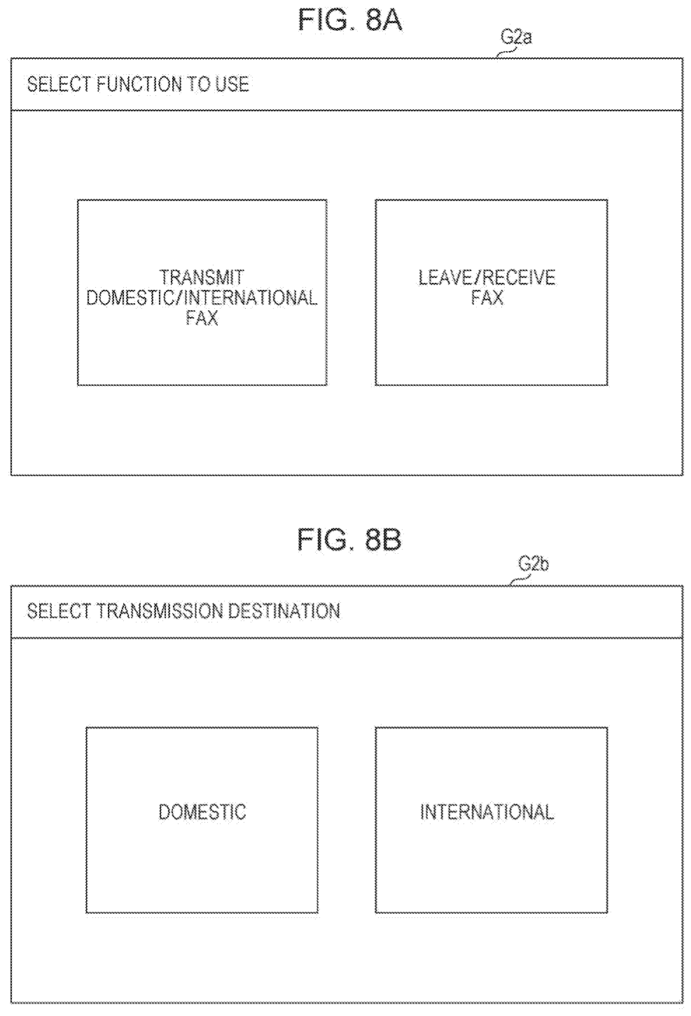

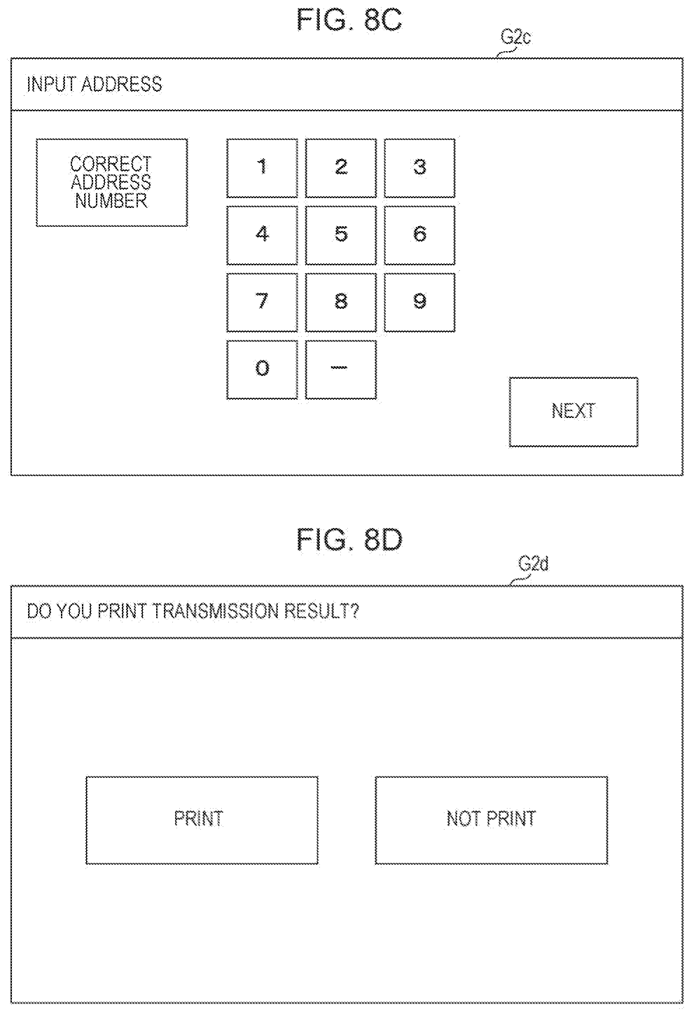

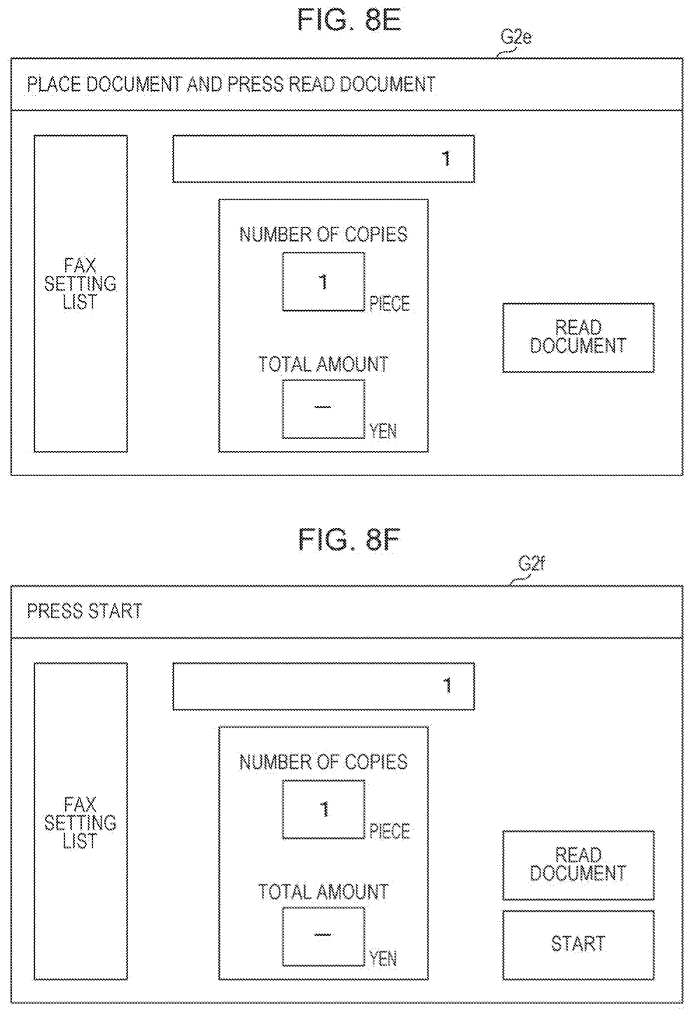

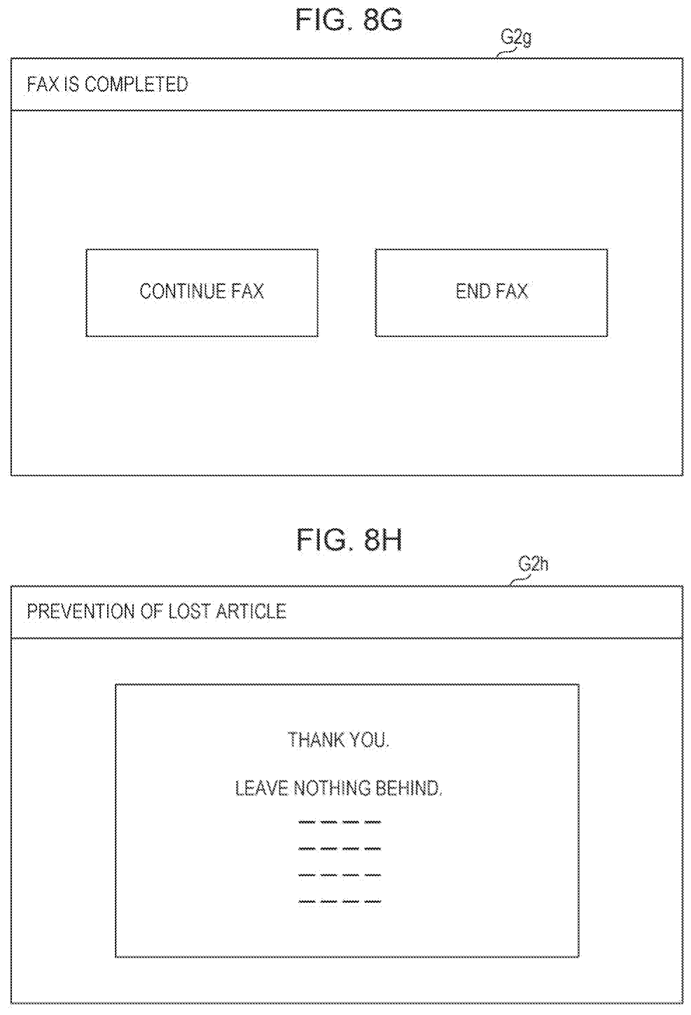

FIGS. 8A to 8H each illustrate a display screen in each setting in the display device in the image forming apparatus according to the second embodiment, and specifically each illustrate a screen for performing the fax processing.

When the user selects “fax” in the display device 164, the display device 164 changes the display from the portal screen G0 to a screen G2a illustrated in FIG. 8A.

The screen G2a is a screen in which whether to transmit or receive a fax is selected. Here, a state where the screen G2a is displayed in the display device 164 corresponds to first setting in a series of operations. Thus, in a case where the user is apart from the image forming apparatus 100 when the screen G2a is displayed, after 10 seconds of detecting the control unit 180 absence of a person in accordance with the detection result of the human detecting sensor 150 (refer to FIG. 4), the display of the display device 164 is changed to the portal screen G0 and the auto-clear is executed. Note that, the display is changed to the portal screen G0 when absence of a person is continuously detected for 10 seconds, and when the user comes back within 10 seconds and the control unit 180 detects presence of a person in accordance with the detection result of the human detecting sensor 150, the screen G2a remains displayed and the auto-clear is not executed.

When the user selects to transmit a fax in the screen G2a, the display device 164 changes the display from the screen G2a to a screen G2b illustrated in FIG. 8B.

The screen G2b is a screen in which whether a transmission destination is a domestic destination or an international destination is selected. Here, a state where the screen G2b is displayed in the display device 164 corresponds to second setting in the series of operations. Thus, in a case where the user is apart from the image forming apparatus 100 when the screen G2b is displayed, after 20 seconds of detecting the control unit 180 absence of a person in accordance with the detection result of the human detecting sensor 150 (refer to FIG. 4), the display of the display device 164 is changed to the portal screen G0 and the auto-clear is executed.

When the user selects whether to transmit the fax to a domestic destination or an international destination in the screen G2b, the display device 164 changes the display from the screen G2b to a screen G2c illustrated in FIG. 8C.

The screen G2c is a screen in which a fax number is input. Here, a state where the screen G2c is displayed in the display device 164 corresponds to third setting in the series of operations. Thus, in a case where the user is apart from the image forming apparatus 100 when the screen G2c is displayed, after 30 seconds of detecting by the control unit 180 absence of a person in accordance with the detection result of the human detecting sensor 150 (refer to FIG. 4), the display of the display device 164 is changed to the portal screen G0 and the auto-clear is executed.

When the user inputs a fax number in the screen G2c, the display device 164 changes the display from the screen G2c to a screen G2d illustrated in FIG. 8D.

The screen G2d is a screen in which whether to print a transmission result is selected. Here, a state where the screen G2d is displayed in the display device 164 corresponds to fourth setting in the series of operations. Thus, in a case where the user is apart from the image forming apparatus 100 when the screen G2d is displayed, similarly to the description with reference to FIGS. 8A to 8C, the auto-clear time is decided, and when the user does not come back within the decided auto-clear time, the display of the display device 164 is changed to the portal screen G0 and the auto-clear is executed.

When the user selects whether to print a transmission result in the screen G2d, the display device 164 changes the display from the screen G2d to a screen G2e illustrated in FIG. 8E.

The screen G2e is a screen in which setting of a document in the document reading device 120 is prompted. Here, a state where the screen G2e is displayed in the display device 164 corresponds to fifth setting in the series of operations. Thus, in a case where the user is apart from the image forming apparatus 100 when the screen G2e is displayed, similarly to the description with reference to FIGS. 8A to 8C, the auto-clear time is decided, and when the user does not come back within the decided auto-clear time, the display of the display device 164 is changed to the portal screen G0 and the auto-clear is executed.

When the user sets a document upon display of the screen G2e, the display device 164 changes the display from the screen G2e to a screen G2f illustrated in FIG. 8F.

The screen G2f is a screen in which start of transmission of a fax is instructed. Here, a state where the screen G2f is displayed in the display device 164 corresponds to sixth setting in the series of operations. Thus, in a case where the user is apart from the image forming apparatus 100 when the screen G2f is displayed, similarly to the description with reference to FIGS. 8A to 8C, the auto-clear time is decided, and when the user does not come back within the decided auto-clear time, the display of the display device 164 is changed to the portal screen G0 and the auto-clear is executed.

When the user instructs start of transmission of a fax in the screen G2f, the display device 164 changes the display from the screen G2f to a screen G2g illustrated in FIG. 8G.

The screen G2g is a screen in which whether to continuously perform the fax operation is selected. Here, a state where the screen G2g is displayed in the display device 164 corresponds to seventh setting in the series of operations. Thus, in a case where the user is apart from the image forming apparatus 100 when the screen G2g is displayed, similarly to the description with reference to FIGS. 8A to 8C, the auto-clear time is decided, and when the user does not come back within the decided auto-clear time, the display of the display device 164 is changed to the portal screen G0 and the auto-clear is executed.

When the user selects to end the fax operation without continuously performing the fax operation in the screen G2g, a job related to the fax processing is completed and the display device 164 changes the display from the screen G2g to a screen G2h illustrated in FIG. 8H. The screen G2h is an end screen.

### Third Embodiment

In a third embodiment, description for the same point as those of the first embodiment and the second embodiment will be omitted and only a difference therefrom will be primarily described.

In the third embodiment, a case where the user selects print processing as a job will be described. The user touches the display device 164 when the portal screen G0 is displayed in the display device 164 (refer to FIG. 6) and thereby selects “print service”.

When the user selects the print processing, the display of the display device 164 shifts to a screen for performing the print processing.

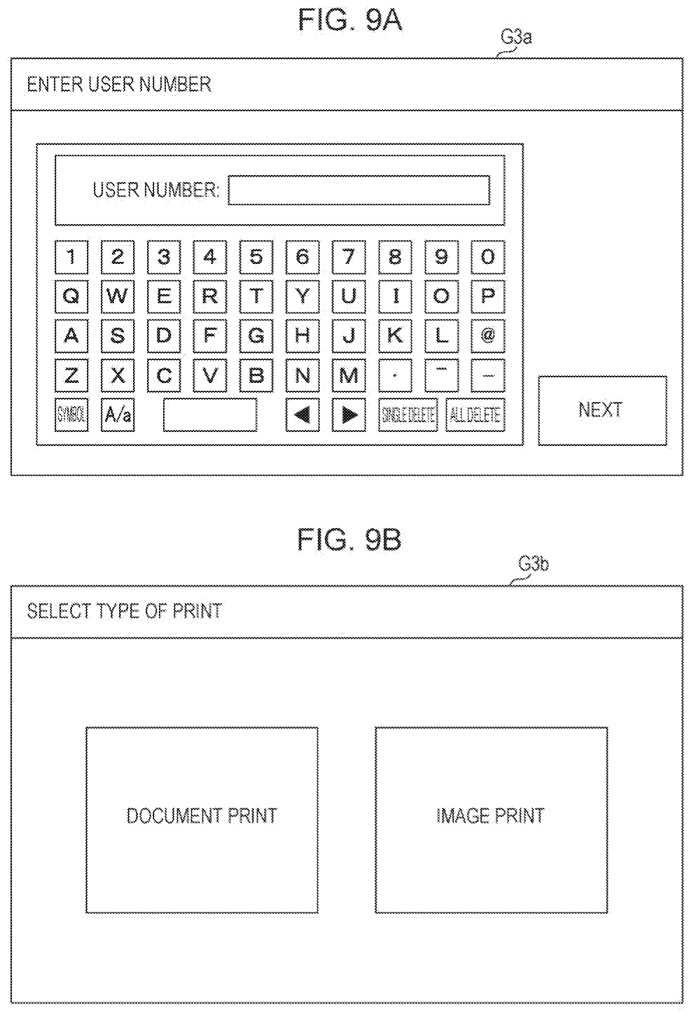

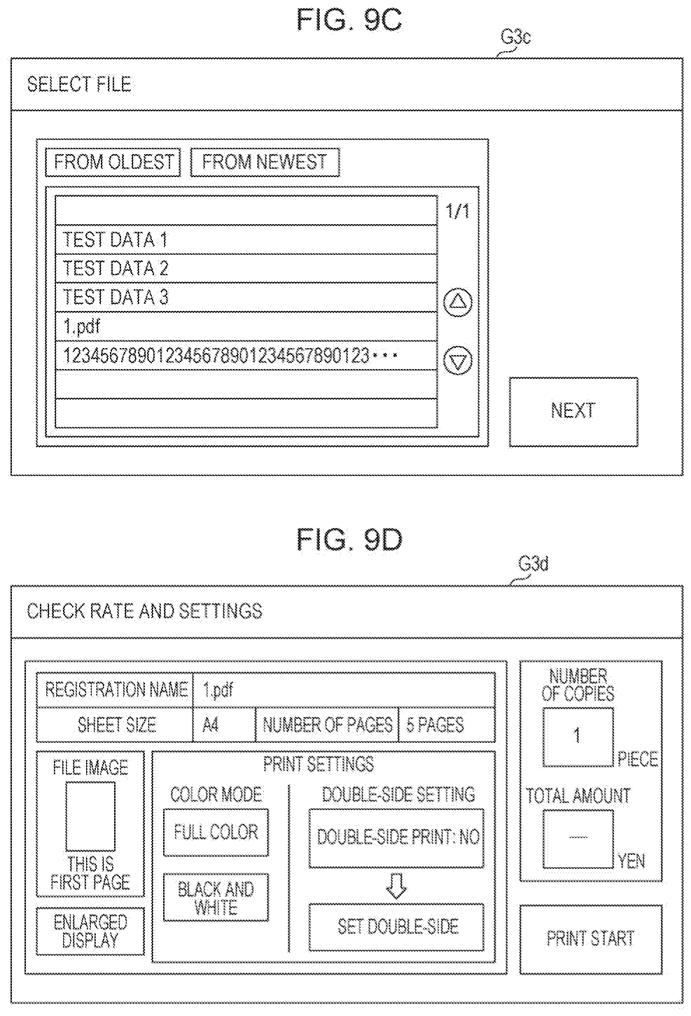

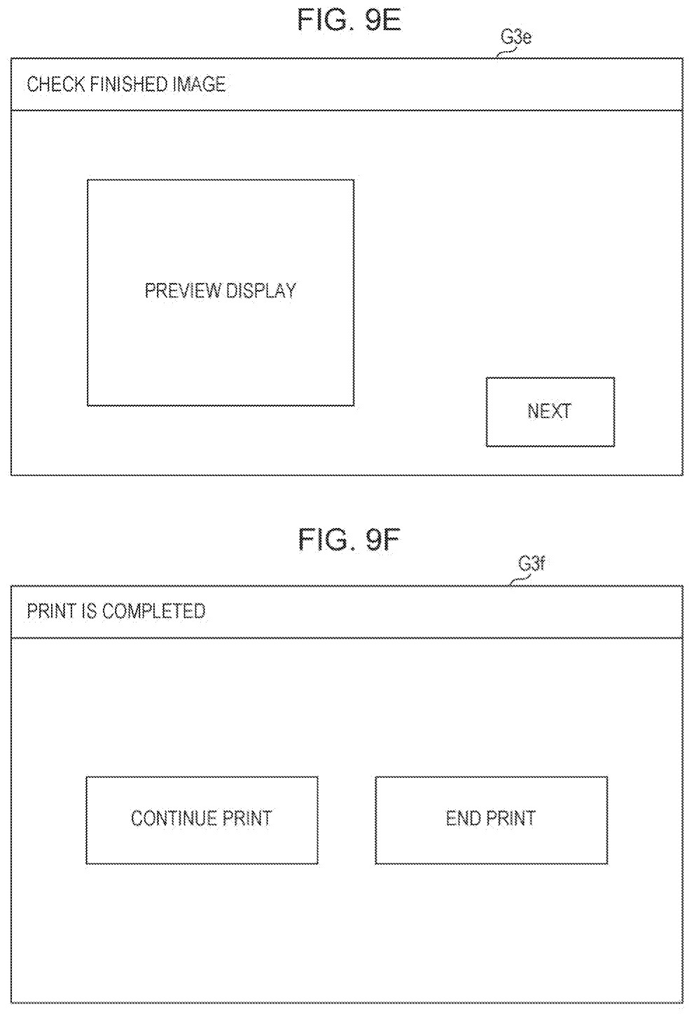

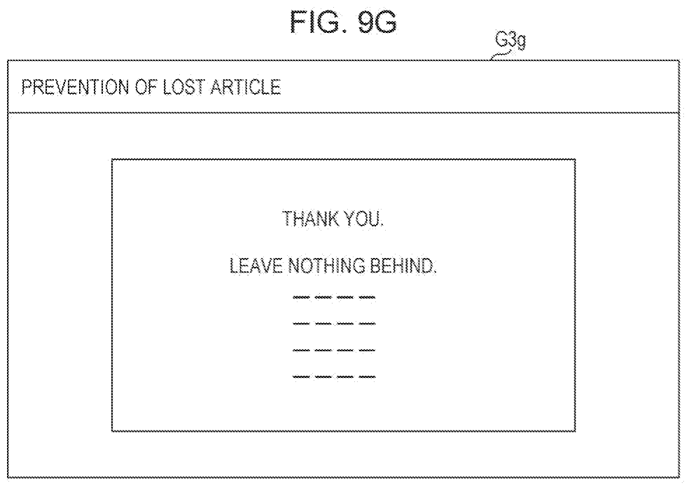

FIGS. 9A to 9G each illustrate a display screen in each setting in the display device in the image forming apparatus according to the third embodiment, and specifically each illustrate a screen for performing the print processing.

When the user selects “print service” in the display device 164, the display device 164 changes the display from the portal screen G0 to a screen G3a illustrated in FIG. 9A.

The screen G3a is a screen in which a user-specific number is entered to perform printing. Here, a state where the screen G3a is displayed in the display device 164 corresponds to first setting in a series of operations. Thus, in a case where the user is apart from the image forming apparatus 100 when the screen G3a is displayed, after 10 seconds of detecting by the control unit 180 absence of a person in accordance with the detection result of the human detecting sensor 150 (refer to FIG. 4), the display of the display device 164 is changed to the portal screen G0 and the auto-clear is executed. Note that, the display is changed to the portal screen G0 when absence of a person is continuously detected for 10 seconds, and when the user comes back within 10 seconds and the control unit 180 detects presence of a person in accordance with the detection result of the human detecting sensor 150, the screen G3a remains displayed and the auto-clear is not executed.

When the user enters a user-specific number in the screen G3a, the display device 164 changes the display from the screen G3a to a screen G3b illustrated in FIG. 9B.

The screen G3b is a screen in which whether a type of print is a document print or an image print is selected. Here, a state where the screen G3b is displayed in the display device 164 corresponds to second setting in the series of operations. Thus, in a case where the user is apart from the image forming apparatus 100 when the screen G3b is displayed, after 20 seconds of detecting by the control unit 180 absence of a person in accordance with the detection result of the human detecting sensor 150 (refer to FIG. 4), the display of the display device 164 is changed to the portal screen G0 and the auto-clear is executed.

When the user selects whether the type of print is a document print or an image print in the screen G3b, the display device 164 changes the display from the screen G3b to a screen G3c illustrated in FIG. 9C.

The screen G3c is a screen in which data to be printed is selected. Here, a state where the screen G3c is displayed in the display device 164 corresponds to third setting in the series of operations. Thus, in a case where the user is apart from the image forming apparatus 100 when the screen G3c is displayed, after 30 seconds of detecting by the control unit 180 absence of a person in accordance with the detection result of the human detecting sensor 150 (refer to FIG. 4), the display of the display device 164 is changed to the portal screen G0 and the auto-clear is executed.

When the user selects data to be printed in the screen G3c, the display device 164 changes the display from the screen G3c to a screen G3d illustrated in FIG. 9D.

The screen G3d is a screen in which the number of copies to be printed or the like is selected and start of printing is instructed. Here, a state where the screen G3d is displayed in the display device 164 corresponds to fourth setting in the series of operations. Thus, in a case where the user is apart from the image forming apparatus 100 when the screen G3d is displayed, similarly to the description with reference to FIGS. 9A to 9C, the auto-clear time is decided, and when the user does not come back within the decided auto-clear time, the display of the display device 164 is changed to the portal screen G0 and the auto-clear is executed.

When the user selects the number of copies to be printed and instructs start of printing in the screen G3d, the display device 164 changes the display from the screen G3d to a screen G3e illustrated in FIG. 9E.

The screen G3e is a screen in which whether to perform preview display of print is selected. Here, a state where the screen G3e is displayed in the display device 164 corresponds to fifth setting in the series of operations. Thus, in a case where the user is apart from the image forming apparatus 100 when the screen G3e is displayed, similarly to the description with reference to FIGS. 9A to 9C, the auto-clear time is decided, and when the user does not come back within the decided auto-clear time, the display of the display device 164 is changed to the portal screen G0 and the auto-clear is executed.

When the user selects not to perform preview display in the screen G3e, print processing is executed and the display device 164 changes the display from the screen G3e to a screen G1f illustrated in FIG. 9F.

The screen G3f is a screen in which whether to continuously perform printing is selected. Here, a state where the screen G3f is displayed in the display device 164 corresponds to sixth setting in the series of operations. Thus, in a case where the user is apart from the image forming apparatus 100 when the screen G3f is displayed, similarly to the description with reference to FIGS. 9A to 9C, the auto-clear time is decided, and when the user does not come back all the time in the decided auto-clear time, the display of the display device 164 is changed to the portal screen G0 and the auto-clear is executed.

When the user selects to end the printing without continuously performing printing in the screen G3f, a job related to the print processing is completed and the display device 164 changes the display from the screen G3f to a screen G3g illustrated in FIG. 9G.

The screen G3g is an end screen. Note that, in a case where the user is apart from the image forming apparatus 100 when the screen G3g is displayed, the display of the display device 164 is immediately changed to the portal screen G0 (refer to FIG. 4).

Though the image forming apparatus 100 according to the embodiments of the disclosure has been described above, a configuration other than the aforementioned configurations may be used. For example, the image forming apparatus 100 may be configured so that, in a case where the control unit 180 detects absence of a person in accordance with the detection result of the human detecting sensor 150 in the middle of a series of operations, the auto-clear time is decided, and when a predetermined time has lapsed in a state where presence of a person is not detected, the auto-clear is executed. Depending on a condition, however, in a case where absence of a person is detected, the auto-clear may be executed without waiting for the predetermined time. For example, in setting at an early stage in the series of operations, the auto-clear may be executed immediately (in 0 second of the auto-clear time) when absence of a person is detected.

In the image forming apparatus 100, the auto-clear times in the portal screen, first setting, second setting, third setting, and job completion are respectively set as 0 second, 10 seconds, 20 seconds, 30 seconds, and 0 second, but are not limited to such values and may be appropriately changed. Though the auto-clear time is set to increase as a stage of the series of operations advances in each setting, the auto-clear time may be fixed or may be decreased in some cases.

The disclosure is not limited to the embodiments described above, but can be carried out in other various forms. Therefore, the embodiments are to be taken in all respects as exemplary only, and are not to be interpreted as being limiting. The scope of the disclosure is indicated by the scope of the Claims and is not restricted in any way to the specification itself. All variations and modifications falling within the equivalency range of the Claims are intended to be embraced in the scope of the Claims.

The present disclosure contains subject matter related to that disclosed in Japanese Priority Patent Application JP 2018-114714 filed in the Japan Patent Office on Jun. 15, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus comprising:
a human detecting sensor that detects a person; and
an operation unit that receives an operation, wherein
the operation unit receives a series of operations having a plurality of stages, and
in a middle stage of the series of operations, in a case where a detection operation of a person by the human detecting sensor is not performed and a predetermined time lapses after the operation is received, the operation that is received is disabled.

2. The image forming apparatus according to claim 1, wherein
in the series of operations having the plurality of stages, which is received by the operation unit, corresponding setting is set for each of the stages, and
the predetermined time is decided in accordance with the setting in the series of operations.

3. The image forming apparatus according to claim 2, wherein
as advancing the stages of the setting in the series of operations, the predetermined time that is decided becomes long.

4. The image forming apparatus according to claim 2, wherein
in a case where the detection operation of a person by the human detecting sensor is not performed, an operation that has been already received is disabled depending on the setting in the series of operations.

5. The image forming apparatus according to claim 1, wherein
in a case where the detection operation of a person by the human detecting sensor is not performed, the operation that is received is disabled depending on a condition.

6. The image forming apparatus according to claim 2, further comprising
a display unit that performs display related to an operation, wherein
the display unit performs display corresponding to the setting.

7. The image forming apparatus according to claim 4, further comprising
a display unit that performs display related to an operation, wherein
the display unit stops display in a case where the operation that is received is disabled.

8. The image forming apparatus according to claim 4, further comprising
a display unit that performs display related to an operation, wherein
the display unit performs initial display in a case where the operation that is received is disabled.
